(19) United States
(12) Patent Application Publication
(10) Pub. No.: US 2026/0064797 A1
(43) Pub. Date: Mar. 5, 2026

(54) METHOD AND APPARATUS FOR EFFICACIOUS TREE SEARCH FOR LLM

(71) Applicant: TENCENT AMERICA LLC, Palo Alto, CA (US)

(72) Inventor: Linfeng SONG, Palo Alto, CA (US)

(73) Assignee: TENCENT AMERICA LLC, Palo Alto, CA (US)

(21) Appl. No.: 18/817,916

(22) Filed: Aug. 28, 2024

(51) Int. Cl. G06F 17/11

(52) U.S. Cl. CPC G06F 17/11

(57) ABSTRACT

A method includes: receiving a text string corresponding to a mathematical question; generating a search tree comprising a plurality of nodes by inputting the text string into a large language model (LLM) N different times, wherein the text string is the root of the search tree, wherein each node other than the root node corresponds to a search trajectory related to the mathematical question, wherein N is an integer greater than zero; determining an expansion score to each node from the plurality of nodes; selecting a node from the plurality of nodes having a highest expansion score; determining a budget for expanding the selected node; expanding the selected node in accordance with the budget by inputting the node and the mathematical questions into the one or more mathematical tasks.

### FIELD

The disclosure generally relates to efficacious tree search for LLM.

### BACKGROUND

Mathematical reasoning tasks have long been acknowledged as challenging. These tasks require transforming a question into a sequence of reasoning steps, which are subsequently executed to derive the correct answer. Recently, large language models (LLMs) have demonstrated remarkable potential in addressing them. A pivotal approach is the employment of Chain-of-Thought (CoT) prompting, which prompts LLMs to break down a question solution into a sequence of reasoning steps before reaching an answer.

Despite their impressive capabilities, LLMs still face challenges when tackling problems with increasing reasoning steps due to the nature of autoregressive decoding. This can be analogous to the “System 1” mode of thought in psychology, which is characterized by fast, intuitive, but error-prone thinking. Growing research attention is being paid to promote the “System 2” mode of thought for LLMs, which is characterized by deliberative thinking steps with back-and-forth refinements. These characterizations are the key features for solving complex math reasoning tasks. Particularly, prior efforts have studied enhancing LLMs both at inference time and through self-improvement using tree search algorithms (e.g., DFS and BFS) and Monte Carlo Tree Search (MCTS).

However, these approaches often necessitate the creation of expert-designed utility functions, making them difficult to be adapted to new scenarios. Moreover, they are computationally intensive, especially when tackling problems that require numerous logical steps. This is because these methods ineffectively manage the expansion budget (the number of nodes to expand) throughout the search process. As a typical example, BFS adopts a constant budget size throughout the search process, overlooking the fact that some tree nodes do not require much expansion. Some MCTS approaches take adaptive budget based on the importance of each node, but they still require a large number of simulations or rollouts for accurate statistics to make decisions, and they overlook other important information, such as the depth (progress) of each node. As the result, there is a pressing need to develop more efficient and adaptable methods for enhancing “System 2” reasoning capabilities of LLMs to effectively handle complex reasoning tasks.

### SUMMARY

According to an aspect of the disclosure, a method performed by at least one processor includes receiving a text string corresponding to a mathematical question; generating a search tree comprising a plurality of nodes by inputting the text string into a large language model (LLM) N different times, wherein the text string is the root of the search tree, wherein each node other than the root node corresponds to a search trajectory related to the mathematical question, wherein N is an integer greater than zero; determining an expansion score to each node from the plurality of nodes; selecting a node from the plurality of nodes having a highest expansion score; determining a budget for expanding the selected node; and expanding the selected node in accordance with the budget by inputting the node and the mathematical questions into the one or more mathematical tasks.

According to an aspect of the disclosure, an apparatus includes: at least one memory configured to store program code; and at least one processor configured to read the program code and operate as instructed by the program code, the program code including: receiving code configured to cause the at least one processor to receive a text string corresponding to a mathematical question; generating code configured to cause the at least one processor to generate a search tree comprising a plurality of nodes by inputting the text string into a large language model (LLM) N different times, wherein the text string is the root of the search tree, wherein each node other than the root node corresponds to a search trajectory related to the mathematical question, wherein N is an integer greater than zero; first determining code configured to cause the at least one processor to determine an expansion score to each node from the plurality of nodes; selecting code configured to cause the at least one processor to select a node from the plurality of nodes having a highest expansion score; second determining code configured to cause the at least one processor to determine a budget for expanding the selected node; expanding code configured to cause the at least one processor to expand the selected node in accordance with the budget by inputting the node and the mathematical questions into the one or more mathematical tasks.

According to an aspect of the disclosure, a non-transitory computer readable medium having instructions stored therein, which when executed by a processor cause the processor to execute a method including receiving a text string corresponding to a mathematical question; generating a search tree comprising a plurality of nodes by inputting the text string into a large language model (LLM) N different times, wherein the text string is the root of the search tree, wherein each node other than the root node corresponds to a search trajectory related to the mathematical question, wherein N is an integer greater than zero; determining an expansion score to each node from the plurality of nodes; selecting a node from the plurality of nodes having a highest expansion score; determining a budget for expanding the selected node; expanding the selected node in accordance with the budget by inputting the node and the mathematical questions into the one or more mathematical tasks.

### BRIEF DESCRIPTION OF THE DRAWINGS

Further features, the nature, and various advantages of the disclosed subject matter will be more apparent from the following detailed description and the accompanying drawings in which:

FIG. 1 is a diagram of an environment in which methods, apparatuses, and systems described herein may be implemented, according to embodiments.

FIG. 2 is a block diagram of example components of one or more devices of FIG. 1.

FIG. 3 is an illustration of an example search tree, according to embodiments.

FIG. 4 is a flowchart of an example process of selecting and expanding a tree node, according to embodiments.

FIG. 5 is a table of test results, according to embodiments.

### DETAILED DESCRIPTION

The following detailed description of example embodiments refers to the accompanying drawings. The same reference numbers in different drawings may identify the same or similar elements.

The foregoing disclosure provides illustration and description, but is not intended to be exhaustive or to limit the implementations to the precise form disclosed. Modifications and variations are possible in light of the above disclosure or may be acquired from practice of the implementations. Further, one or more features or components of one embodiment may be incorporated into or combined with another embodiment (or one or more features of another embodiment). Additionally, in the flowcharts and descriptions of operations provided below, it is understood that one or more operations may be omitted, one or more operations may be added, one or more operations may be performed simultaneously (at least in part), and the order of one or more operations may be switched.

It will be apparent that systems and/or methods, described herein, may be implemented in different forms of hardware, firmware, or a combination of hardware and software. The actual specialized control hardware or software code used to implement these systems and/or methods is not limiting of the implementations. Thus, the operation and behavior of the systems and/or methods were described herein without reference to specific software code—it being understood that software and hardware may be designed to implement the systems and/or methods based on the description herein.

Even though particular combinations of features are recited in the claims and/or disclosed in the specification, these combinations are not intended to limit the disclosure of possible implementations. In fact, many of these features may be combined in ways not specifically recited in the claims and/or disclosed in the specification. Although each dependent claim listed below may directly depend on only one claim, the disclosure of possible implementations includes each dependent claim in combination with every other claim in the claim set.

No element, act, or instruction used herein should be construed as critical or essential unless explicitly described as such. Also, as used herein, the articles “a” and “an” are intended to include one or more items, and may be used interchangeably with “one or more.” Where only one item is intended, the term “one” or similar language is used. Also, as used herein, the terms “has,” “have,” “having,” “include,” “including,” or the like are intended to be open-ended terms. Further, the phrase “based on” is intended to mean “based, at least in part, on” unless explicitly stated otherwise. Furthermore, expressions such as “at least one of [A] and [B]” or “at least one of [A] or [B]” are to be understood as including only A, only B, or both A and B.

Reference throughout this specification to “one embodiment,” “an embodiment,” or similar language means that a particular feature, structure, or characteristic described in connection with the indicated embodiment is included in at least one embodiment of the present solution. Thus, the phrases “in one embodiment”, “in an embodiment,” and similar language throughout this specification may, but do not necessarily, all refer to the same embodiment.

Furthermore, the described features, advantages, and characteristics of the present disclosure may be combined in any suitable manner in one or more embodiments. One skilled in the relevant art will recognize, in light of the description herein, that the present disclosure may be practiced without one or more of the specific features or advantages of a particular embodiment. In other instances, additional features and advantages may be recognized in certain embodiments that may not be present in all embodiments of the present disclosure.

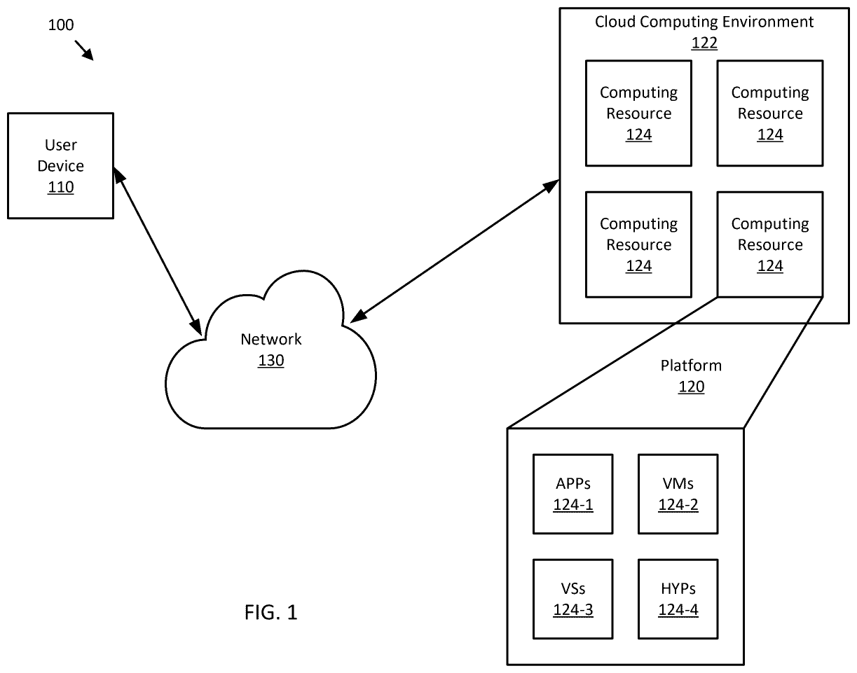

FIG. 1 is a diagram of an environment 100 in which methods, apparatuses, and systems described herein may be implemented, according to embodiments. As shown in FIG. 1, the environment 100 may include a user device 110, a platform 120, and a network 130. Devices of the environment 100 may interconnect via wired connections, wireless connections, or a combination of wired and wireless connections.

The user device 110 includes one or more devices capable of receiving, generating, storing, processing, and/or providing information associated with platform 120. For example, the user device 110 may include a computing device (e.g., a desktop computer, a laptop computer, a tablet computer, a handheld computer, a smart speaker, a server, etc.), a mobile phone (e.g., a smart phone, a radiotelephone, etc.), a wearable device (e.g., a pair of smart glasses or a smart watch), or a similar device. In some implementations, the user device 110 may receive information from and/or transmit information to the platform 120.

The platform 120 includes one or more devices as described elsewhere herein. In some implementations, the platform 120 may include a cloud server or a group of cloud servers. In some implementations, the platform 120 may be designed to be modular such that software components may be swapped in or out depending on a particular need. As such, the platform 120 may be easily and/or quickly reconfigured for different uses.

In some implementations, as shown, the platform 120 may be hosted in a cloud computing environment 122. Notably, while implementations described herein describe the platform 120 as being hosted in the cloud computing environment 122, in some implementations, the platform 120 may not be cloud-based (i.e., may be implemented outside of a cloud computing environment) or may be partially cloud-based.

The cloud computing environment 122 includes an environment that hosts the platform 120. The cloud computing environment 122 may provide computation, software, data access, storage, etc. services that do not require end-user (e.g. the user device 110) knowledge of a physical location and configuration of system(s) and/or device(s) that hosts the platform 120. As shown, the cloud computing environment 122 may include a group of computing resources 124 (referred to collectively as “computing resources 124” and individually as “computing resource 124”).

The computing resource 124 includes one or more personal computers, workstation computers, server devices, or other types of computation and/or communication devices. In some implementations, the computing resource 124 may host the platform 120. The cloud resources may include compute instances executing in the computing resource 124, storage devices provided in the computing resource 124, data transfer devices provided by the computing resource 124, etc. In some implementations, the computing resource 124 may communicate with other computing resources 124 via wired connections, wireless connections, or a combination of wired and wireless connections.

As further shown in FIG. 1, the computing resource 124 includes a group of cloud resources, such as one or more applications (APPs) 124-1, one or more virtual machines (VMs) 124-2, virtualized storage (VSS) 124-3, one or more hypervisors (HYPs) 124-4, or the like.

The application 124-1 includes one or more software applications that may be provided to or accessed by the user device 110 and/or the platform 120. The application 124-1 may eliminate a need to install and execute the software applications on the user device 110. For example, the application 124-1 may include software associated with the platform 120 and/or any other software capable of being provided via the cloud computing environment 122. In some implementations, one application 124-1 may send/receive information to/from one or more other applications 124-1, via the virtual machine 124-2.

The virtual machine 124-2 includes a software implementation of a machine (e.g. a computer) that executes programs like a physical machine. The virtual machine 124-2 may be either a system virtual machine or a process virtual machine, depending upon use and degree of correspondence to any real machine by the virtual machine 124-2. A system virtual machine may provide a complete system platform that supports execution of a complete operating system (OS). A process virtual machine may execute a single program, and may support a single process. In some implementations, the virtual machine 124-2 may execute on behalf of a user (e.g. the user device 110), and may manage infrastructure of the cloud computing environment 122, such as data management, synchronization, or long-duration data transfers.

The virtualized storage 124-3 includes one or more storage systems and/or one or more devices that use virtualization techniques within the storage systems or devices of the computing resource 124. In some implementations, within the context of a storage system, types of virtualizations may include block virtualization and file virtualization. Block virtualization may refer to abstraction (or separation) of logical storage from physical storage so that the storage system may be accessed without regard to physical storage or heterogeneous structure. The separation may permit administrators of the storage system flexibility in how the administrators manage storage for end users. File virtualization may eliminate dependencies between data accessed at a file level and a location where files are physically stored. This may enable optimization of storage use, server consolidation, and/or performance of non-disruptive file migrations.

The hypervisor 124-4 may provide hardware virtualization techniques that allow multiple operating systems (e.g. “guest operating systems”) to execute concurrently on a host computer, such as the computing resource 124. The hypervisor 124-4 may present a virtual operating platform to the guest operating systems, and may manage the execution of the guest operating systems. Multiple instances of a variety of operating systems may share virtualized hardware resources.

The network 130 includes one or more wired and/or wireless networks. For example, the network 130 may include a cellular network (e.g. a fifth generation (5G) network, a long-term evolution (LTE) network, a third generation (3G) network, a code division multiple access (CDMA) network, etc.), a public land mobile network (PLMN), a local area network (LAN), a wide area network (WAN), a metropolitan area network (MAN), a telephone network (e.g. the Public Switched Telephone Network (PSTN)), a private network, an ad hoc network, an intranet, the Internet, a fiber optic-based network, or the like, and/or a combination of these or other types of networks.

The number and arrangement of devices and networks shown in FIG. 1 are provided as an example. In practice, there may be additional devices and/or networks, fewer devices and/or networks, different devices and/or networks, or differently arranged devices and/or networks than those shown in FIG. 1. Furthermore, two or more devices shown in FIG. 1 may be implemented within a single device, or a single device shown in FIG. 1 may be implemented as multiple, distributed devices. Additionally, or alternatively, a set of devices (e.g. one or more devices) of the environment 100 may perform one or more functions described as being performed by another set of devices of the environment 100.

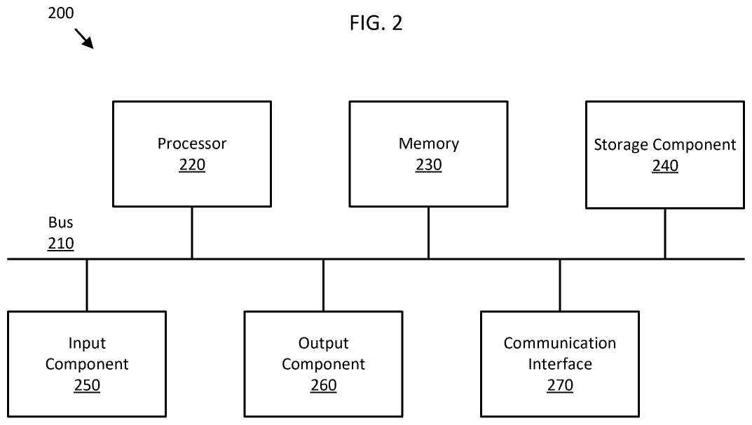

FIG. 2 is a block diagram of example components of one or more devices of FIG. 1. The device 200 may correspond to the user device 110 and/or the platform 120. As shown in FIG. 2, the device 200 may include a bus 210, a processor 220, a memory 230, a storage component 240, an input component 250, an output component 260, and a communication interface 270.

The bus 210 includes a component that permits communication among the components of the device 200. The processor 220 is implemented in hardware, firmware, or a combination of hardware and software. The processor 220 is a central processing unit (CPU), a graphics processing unit (GPU), an accelerated processing unit (APU), a microprocessor, a microcontroller, a digital signal processor (DSP), a field-programmable gate array (FPGA), an application-specific integrated circuit (ASIC), or another type of processing component. In some implementations, the processor 220 includes one or more processors capable of being programmed to perform a function. The memory 230 includes a random access memory (RAM), a read only memory (ROM), and/or another type of dynamic or static storage device (e.g. a flash memory, a magnetic memory, and/or an optical memory) that stores information and/or instructions for use by the processor 220.

The storage component 240 stores information and/or software related to the operation and use of the device 200. For example, the storage component 240 may include a hard disk (e.g. a magnetic disk, an optical disk, a magneto-optic disk, and/or a solid state disk), a compact disc (CD), a digital versatile disc (DVD), a floppy disk, a cartridge, a magnetic tape, and/or another type of non-transitory computer-readable medium, along with a corresponding drive.

The input component 250 includes a component that permits the device 200 to receive information, such as via user input (e.g. a touch screen display, a keyboard, a keypad, a mouse, a button, a switch, and/or a microphone). Additionally, or alternatively, the input component 250 may include a sensor for sensing information (e.g. a global positioning system (GPS) component, an accelerometer, a gyroscope, and/or an actuator). The output component 260 includes a component that provides output information from the device 200 (e.g. a display, a speaker, and/or one or more light-emitting diodes (LEDs)).

The communication interface 270 includes a transceiver-like component (e.g., a transceiver and/or a separate receiver and transmitter) that enables the device 200 to communicate with other devices, such as via a wired connection, a wireless connection, or a combination of wired and wireless connections. The communication interface 270 may permit the device 200 to receive information from another device and/or provide information to another device. For example, the communication interface 270 may include an Ethernet interface, an optical interface, a coaxial interface, an infrared interface, a radio frequency (RF) interface, a universal serial bus (USB) interface, a Wi-Fi interface, a cellular network interface, or the like.

The device 200 may perform one or more processes described herein. The device 200 may perform these processes in response to the processor 220 executing software instructions stored by a non-transitory computer-readable medium, such as the memory 230 and/or the storage component 240. A computer-readable medium is defined herein as a non-transitory memory device. A memory device includes memory space within a single physical storage device or memory space spread across multiple physical storage devices.

Software instructions may be read into the memory 230 and/or the storage component 240 from another computer-readable medium or from another device via the communication interface 270. When executed, software instructions stored in the memory 230 and/or the storage component 240 may cause the processor 220 to perform one or more processes described herein. Additionally, or alternatively, hardwired circuitry may be used in place of or in combination with software instructions to perform one or more processes described herein. Thus, implementations described herein are not limited to any specific combination of hardware circuitry and software.

The number and arrangement of components shown in FIG. 2 are provided as an example. In practice, the device 200 may include additional components, fewer components, different components, or differently arranged components than those shown in FIG. 2. Additionally, or alternatively, a set of components (e.g. one or more components) of the device 200 may perform one or more functions described as being performed by another set of components of the device 200.

Recent research suggests that tree search algorithms (e.g. Monte Carlo Tree Search) can dramatically boost LLM performance on complex mathematical reasoning tasks. However, they often require more than 10 times the computational resources of greedy decoding due to wasteful search strategies, making them difficult to be deployed in practical applications. Current search-based methods are computationally intensive and slow. Having access to such amount of resource for training speech recognition is impractical in most of the scenarios.

Embodiments of the present disclosure are directed to a novel guided tree search algorithm with dynamic node selection and node-level exploration budget (e.g., maximum number of children) calculation to tackle this issue. By considering the search progress towards the final answer (history) and the guidance from a value network (future) trained without any step-wise annotations, the embodiments of the present disclosure iteratively select the most promising tree node before expanding it within the boundaries of the allocated computational budget. Experiments conducted on the GSM8K and TabMWP datasets demonstrate that the embodiments of the present disclosure not only offers competitive performance but also enjoys significantly lower computational costs compared to baseline methods.

The embodiments of the present disclosure provide a guided tree search algorithm with dynamic node selection and node-level exploration budget calculation, aiming to maintain the performance at a moderate cost. The embodiments of the present disclosure result in an approach that is both accurate and deployable.

The embodiments of the present disclosure provide a guided tree search algorithm with dynamic node selection and node-level exploration budget calculation, aiming to maintain the performance at a moderate cost. In one or more examples, a value score is employed as guidance to select the most promising node for the next action and expand it within a dynamically computed budget size, navigating exploration-exploitation balance for guided tree search. Operations of selection and expansion may be iterated until the resulting trajectory either meets the expected quality score or surpasses the maximum number of iterations. Notably, the computational budget for each node is inversely correlated to its value score. This is inspired by the observation that nodes with higher value scores are more likely to yield the correct solution upon expansion. As a result fewer computational resources are allocated to them to prevent unnecessary computation and vice versa. These features not only promote efficient exploitation, facilitating a faster convergence to the final answer, but also guarantees sufficient exploration to cover enough state space for maintaining performance.

In one or more examples, taking each math reasoning question q as a tree search problem, the root of the search tree is initialized with question q, while the other tree nodes represent reasoning steps (e.g., sᵢ) generated by an LLM (e.g., denoted as policy π). In one or more examples, an (incomplete) trajectory q, s₁, . . . , sᵢ is treated as the state Sᵢ (Specially, S₀=q). Then, a next step may be sampled from the LLM which consumes Sᵢ:

$${s}_{i + 1} ∼ LLM ( D , {S}_{i} ) , \qquad Eq . ( 1 )$$

where D is the in-context demonstrations made of question-solution pairs.

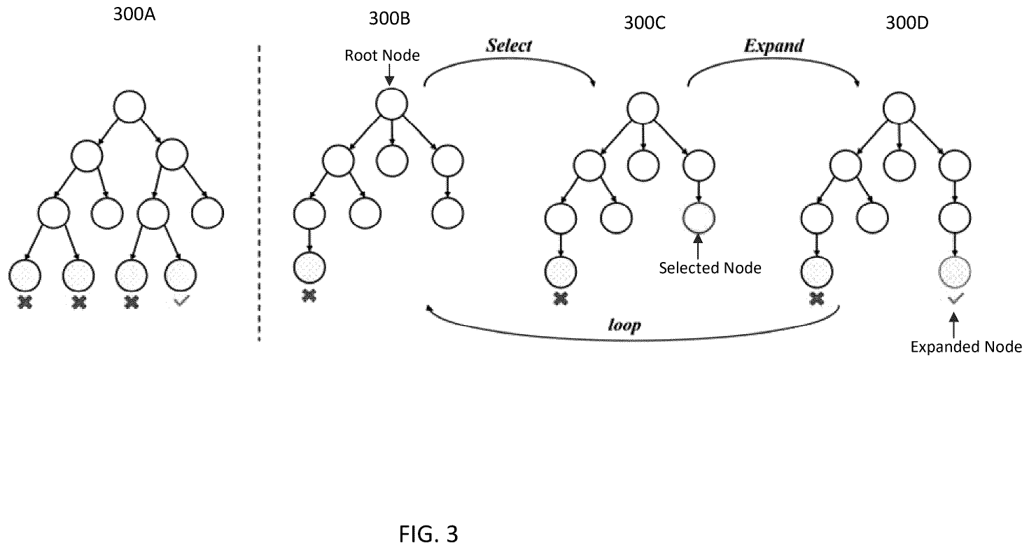

FIG. 3 illustrates an example frame for a guided tree search. The BFS method is shown in 300A. The guided tree search may start with tree 300B. A node in the tree 300C is selected, and the selected node is expanded in tree 300D. The embodiments of the present disclosure may dynamically select the most promising node and expand it within an offered budge, thus reaching the answer without visiting unnecessary nodes.

As shown in FIG. 3, the embodiments comprise an iterative process of Selection and Expansion operations. For each loop, the most promising node is selected, and then expand within the constraints of a computed budget. In one or more examples, both operations may be guided by a value network v. The algorithm may terminate when the generated answers meet the expected value threshold ε or the number of iterations reaches the limit N.

According to one or more embodiments, selection may be performed by selecting the tree node with the highest value for expansion. In one or more examples, a progress term, denoted as p(S), may be introduced, which quantifies the advancement of a state S towards the goal within the search trajectory. By incorporating this term, the exploration of nodes that are expected to lead more rapidly to the final answer is prioritized.

An expansion score (e.g., value for expansion), may be computed as follows:

$${s}^{′} = {max}_{{s}_{i}} ( v ( {S}_{i} ) + λ p ( {S}_{i} ) ) , \qquad Eq . ( 2 )$$

where s′ denotes the selected node, and λ is introduced to regulate the impact of the progress term. Since estimating the progress of a state is non-trivial, an empirical approach based on the trajectory of greedy decoding is introduced. In one or more examples, the progress may be computed by comparing the number of tokens or steps from a given state to those of the corresponding greedy decoding. For example, when using step number as the metric, a state with d steps (e.g., steps of current node to root node) has progress of d/\hat{d}, where \hat{d} denotes the total number of steps in the greedy decoded trajectory. In one or more examples, a greedy algorithm takes all of the data in a particular problem, and then sets a rule for which elements to add to the solution at each step of the algorithm.

According to one or more examples, during the expansion phase, balance exploitation and exploration may be balanced by effectively managing the computation budget allocated to the selected node. In one or more examples, an appropriate budget size may promote efficient exploitation, facilitating a faster convergence to the final answer, while also guaranteeing sufficient exploration to cover enough state space for reducing uncertainty. In one or more examples, a budget size may be an integer value corresponding to one or more tokens. The budget size may correspond to a maximum number of nodes that may be added to tree. For example, when a budget size is three tokens, a maximum of three nodes may be added to a tree during the expansion phase. The embodiments include two expansion strategies: Incremental Expansion and Batch Expansion.

According to one or more embodiments, the allocated budget for a node S may be defined as the maximum number of its children, denoted as b, which primarily depends on the value v(S) and depth d of that node.

$$b = min ( ⌈ \frac{log ( 1 - ϵ )}{d log ( 1 - v ( S ) )} ⌉ , B ) , \qquad Eq . ( 3 )$$

where B denotes the upper bound of the budget and ∈ is the expected accuracy, thus a larger ∈ (e.g., 0.95) encourages more conservative searching. Besides, we employ the 1/d term, which fosters exploration at the start of searching but encourages exploitation with d increasing to avoid search space explosion.

In one or more examples, the incremental approach incrementally expands one child node after another. If the budget allows, the same node can be reselected until the budget is fully utilized. This method tends to conserve computational resources by carefully managing the budget. In the incremental approach, for example, a node S1 may be selected and expanded with a budget of 2 (e.g., two iterations). In a first iteration, node S1-1 may be generated by inputting q and S1 into the LLM (e.g., LLM (q, S1)). After the first iteration, the budget is decremented by 1. In a second iteration, node S1-2 may be generated by inputting q and S1-2 into the LLM. After the second iteration, the budget is decremented by 1. In this example, the incremental expansion is stopped after two iterations since the budget is decremented to 0.

In one or more examples, the batch expansion approach consumes the entire budget allocated to a node during each iteration, resulting in the generation of multiple child nodes simultaneously. This method broadens the search space for subsequent iterations, potentially leading to the identification of superior nodes and enhancing overall performance. In the incremental approach, for example, a node S1 may be selected and expanded with a budget of 2. For example, the question q and the node S1 may be inputted into the LLM twice to obtain 2 new expanded nodes.

According to one or more embodiments, the value network v(S) seeks to approximate the expected cumulative reward starting from state S and following a policy π thereafter. This can be represented as v(S)=E_{π}[Rₜ|Sₜ=S], where Rₜ is the discounted return starting from state Sₜ. Particularly, given a question q and its correct answer y from an expert demonstration dataset. Each trajectory with reasoning steps (e.g., sᵢ) and final predicted answer ŷ is firstly sampled from the policy π:

$${s}_{1} , … , {s}_{n} , \hat{y} ∼ LLM ( D , q ) \qquad Eq . ( 4 )$$

In one or more examples, the answer correctness as distant supervision for each reasoning step is taken to train the value network via Mean Squared Error (MSE) loss:

$${L}_{vn} = {( v ( S ) - 𝕀 [ y = \hat{y} ] )}^{2} , \qquad Eq . ( 5 )$$

where [symbol] denotes an indicator function.

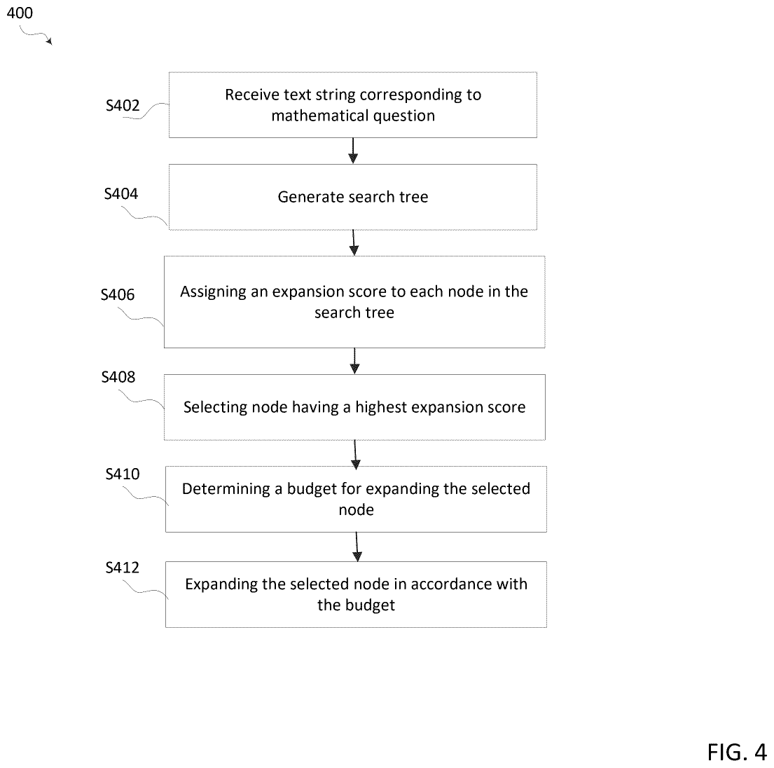

FIG. 4 illustrates a flowchart of an example process 400 of performing selecting and expanding of a tree node. The process 400 may be performed by the device 200.

The process may start at operation S402 where a text string corresponding to a mathematical question is received. An example math question or word problem may be, but not limited to, one of the following: (i) “Old Town Bike Rental Shop charges 20 dollars plus 7 dollars an hour for renting a bike. Ted paid 80 dollars to rent a bike. How many hours did he pay to have the bike checked out?”; (ii) “Jane collects stamps. In her album she can fit 20 stamps on a page. She has filled 12 pages. How many stamps has Mary collected?”; (iii) “Mike put 3 soufflés in his oven at 5:00 pm. He cooked them for 15 minutes. He repeated this process two more times. At what time did he finish cooking all the soufflés.”

The process proceeds to operation S404 where a search tree is generated. For example, the text string (e.g., q) may be inputted into the LLM N times to generate a search tree, where N is an integer greater than zero. The root of the tree may be q.

The process proceeds to operation S406 where an expansion score is assigned to each node in the search tree. For example, the expansion score may be determined in accordance with Eq. (2).

The process proceeds to operation S408 where a node with the highest expansion score is selected.

The process proceeds to operation S410 where a budget is determined for expanding the selected node. For example, the budget may be determined in accordance with Eq. (3).

The process proceeds to operation S412 where the selected node is expanded in accordance with the budget. For example, the selected node may be expanded in accordance with the incremental expansion method or the batch expansion method described above.

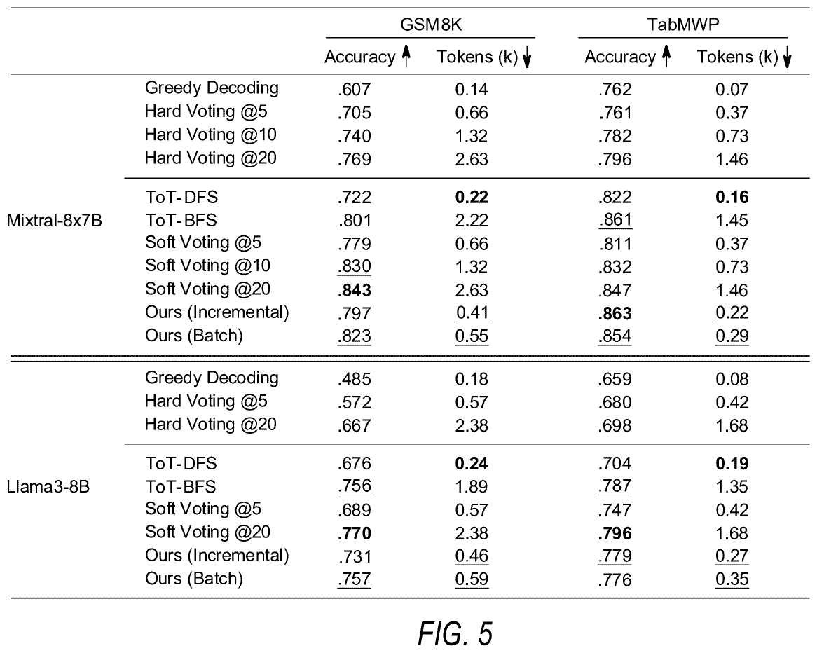

FIG. 5 illustrates a table demonstrating results using the embodiments of the present disclosure.

The table in FIG. 5 compares the performance of the following methods with the embodiments of the present disclosure.

Greedy Decoding: Intuitively selects the most probable next token at each decoding step.

Hard Voting@K: Known as self-consistency, which ensembles the answers from multiple sampled solutions as the final answer using majority voting. The method is performed with sample K={5, 10, 20} times and with a temperature of 0.6.

ToT-DFS: This method is implemented by capitalizing on guidance from the trained value network. Specifically, a node is pruned if its value score falls below a threshold of 0.5 and limit the maximum number of children to 5 to prevent infinite loops.

ToT-BFS: These two methods work similarly for this task. Leveraging the value networks, each node may be expanded by 5 children, where 5 nodes with the highest value scores are kept at each depth to avoid search space explosion.

Soft Voting@K: This method is an enhancement over hard voting by utilizing the value networks. This method softly ensembles the answers of different paths by taking their value scores as weights.

As shown, in FIG. 5, the embodiments of the present disclosure fall within the cost range of ToT-DFS and Soft Voting@5, yet yields significantly better performance.

The proposed methods disclosed herein may be implemented by processing circuitry (e.g., one or more processors or one or more integrated circuits). In one example, the one or more processors execute a program that is stored in a non-transitory computer-readable medium to perform one or more of the proposed methods.

The techniques described above may be implemented as computer software using computer-readable instructions and physically stored in one or more computer-readable media.

Embodiments of the present disclosure may be used separately or combined in any order. Further, each of the embodiments (and methods thereof) may be implemented by processing circuitry (e.g., one or more processors or one or more integrated circuits). In one example, the one or more processors execute a program that is stored in a non-transitory computer-readable medium.

The foregoing disclosure provides illustration and description, but is not intended to be exhaustive or to limit the implementations to the precise form disclosed. Modifications and variations are possible in light of the above disclosure or may be acquired from practice of the implementations.

As used herein, the term component is intended to be broadly construed as hardware, firmware, or a combination of hardware and software.

Even though combinations of features are recited in the claims and/or disclosed in the specification, these combinations are not intended to limit the disclosure of possible implementations. In fact, many of these features may be combined in ways not specifically recited in the claims and/or disclosed in the specification. Although each dependent claim listed below may directly depend on only one claim, the disclosure of possible implementations includes each dependent claim in combination with every other claim in the claim set.

No element, act, or instruction used herein should be construed as critical or essential unless explicitly described as such. Also, as used herein, the articles “a” and “an” are intended to include one or more items, and may be used interchangeably with “one or more.” Furthermore, as used herein, the term “set” is intended to include one or more items (e.g., related items, unrelated items, a combination of related and unrelated items, etc.), and may be used interchangeably with “one or more.” Where only one item is intended, the term “one” or similar language is used. Also, as used herein, the terms “has,” “have,” “having,” or the like are intended to be open-ended terms. Further, the phrase “based on” is intended to mean “based, at least in part, on” unless explicitly stated otherwise.

What is claimed is:

1. A method performed by at least one processor, the method comprising:
receiving a text string corresponding to a mathematical question;
generating a search tree comprising a plurality of nodes by inputting the text string into a large language model (LLM) N different times, wherein the text string is the root of the search tree, wherein each node other than the root node corresponds to a search trajectory related to the mathematical question, wherein N is an integer greater than zero;
determining an expansion score to each node from the plurality of nodes;
selecting a node from the plurality of nodes having a highest expansion score;
determining a budget for expanding the selected node; and
expanding the selected node in accordance with the budget by inputting the node and the mathematical questions into the one or more mathematical tasks.

2. The method according to claim 1, wherein the expansion score of the selected node is based on an expected degree of success that the respective node corresponds to a correct answer to the mathematical question.

3. The method according to claim 1, wherein the expansion score of the selected node is based on a progress term corresponding to a ratio between a number of steps of the selected node from the root node and a number of steps corresponding to a greedy decoded trajectory.

4. The method according to claim 1, wherein the budget for the selected node is determined based on an expected accuracy, a number of steps of the selected node from the root node, and an upper bound of the budget.

5. The method according to claim 1, wherein the expanding the selected node comprises expanding the search tree incrementally in which the selected node and each created node from the selected node is input into the LLM until with the mathematical question until the budget is utilized.

6. The method according to claim 1, wherein the expanding the selected node comprises simultaneously expanding the selected node in which the selected node is input into the LLM with the questions a predetermined number of times in accordance with the budget.

7. The method according to claim 1, wherein the selecting the node and the expanding the selected node are iteratively performed until a predetermined condition is satisfied.

8. The method according to claim 7, wherein the predetermined condition specifies that the search tree includes an answer that is equal to or greater than an expected accuracy threshold.

9. The method according to claim 7, wherein the predetermined condition specifies that a number of iterations reaches a predetermined limit.

10. An apparatus comprising:
at least one memory configured to store program code; and
at least one processor configured to read the program code and operate as instructed by the program code, the program code including:
receiving code configured to cause the at least one processor to receive a text string corresponding to a mathematical question;
generating code configured to cause the at least one processor to generate a search tree comprising a plurality of nodes by inputting the text string into a large language model (LLM) N different times, wherein the text string is the root of the search tree, wherein each node other than the root node corresponds to a search trajectory related to the mathematical question, wherein N is an integer greater than zero;
first determining code configured to cause the at least one processor to determine an expansion score to each node from the plurality of nodes;
selecting code configured to cause the at least one processor to select a node from the plurality of nodes having a highest expansion score;
second determining code configured to cause the at least one processor to determine a budget for expanding the selected node;
expanding code configured to cause the at least one processor to expand the selected node in accordance with the budget by inputting the node and the mathematical questions into the one or more mathematical tasks.

11. The apparatus according to claim 10, wherein the expansion score of the selected node is based on an expected degree of success that the respective node corresponds to a correct answer to the mathematical question.

12. The apparatus according to claim 10, wherein the expansion score of the selected node is based on a progress term corresponding to a ratio between a number of steps of the selected node from the root node and a number of steps corresponding to a greedy decoded trajectory.

13. The apparatus according to claim 10, wherein the budget for the selected node is determined based on an expected accuracy, a number of steps of the selected node from the root node, and an upper bound of the budget.

14. The apparatus according to claim 10, wherein the expanding code is further configured to cause the at least one processor to expand the selected node incrementally in which the selected node and each created node from the selected node is input into the LLM until with the mathematical question until the budget is utilized.

15. The apparatus according to claim 10, wherein the expanding code is further configured to cause the at least one processor to simultaneously expanding the selected node in which the selected node is input into the LLM with the questions a predetermined number of times in accordance with the budget.

16. The apparatus according to claim 10, wherein the selection of the node and the expansion of the selected node are iteratively performed until a predetermined condition is satisfied.

17. The apparatus according to claim 16, wherein the predetermined condition specifies that the search tree includes an answer that is equal to or greater than an expected accuracy threshold.

18. The apparatus according to claim 16, wherein the predetermined condition specifies that a number of iterations reaches a predetermined limit.

19. A non-transitory computer readable medium having instructions stored therein, which when executed by a processor cause the processor to execute a method comprising:
receiving a text string corresponding to a mathematical question;
generating a search tree comprising a plurality of nodes by inputting the text string into a large language model (LLM) N different times, wherein the text string is the root of the search tree, wherein each node other than the root node corresponds to a search trajectory related to the mathematical question, wherein N is an integer greater than zero;
determining an expansion score to each node from the plurality of nodes;
selecting a node from the plurality of nodes having a highest expansion score;
determining a budget for expanding the selected node;
expanding the selected node in accordance with the budget by inputting the node and the mathematical questions into the one or more mathematical tasks.

20. The non-transitory computer readable medium according to claim 19, wherein the expansion score of the selected node is based on an expected degree of success that the respective node corresponds to a correct answer to the mathematical question.
